(19) United States
(12) Patent Application Publication
(10) Pub. No.: US 2012/0167422 A1
(43) Pub. Date: Jul. 5, 2012

(54) Multi- coloured Crosswalk Sign with Distinctive 3 D Vision

(76) Inventors: Chun Huang, Markham (CA); Zhi Jing Huang, Markham (CA); Ren Zhi Lou, Markham (CA)

(21) Appl. No.: 13/374,547

(22) Filed: Dec. 21, 2010

(51) Int. Cl. G09F 13/20; G09F 19/22; G09F 7/00

(52) U.S. Cl. 40/542; 40/612

(57) ABSTRACT

This design is a new multi-colored crosswalk sign with distinctive 3D vision. It belongs to road traffic sign field and includes crosswalk sign, crosswalk lane line with two trapezoids added to both ends of the white rectangle and parallel elongate trapezoids designed on both sides of the white rectangle. The trapezoids at both ends and the parallel elongate trapezoids on both sides are in different colors so that the crosswalk sign takes the appearance of distinctive 3D vision, which reminds pedestrians and drivers to be more careful.

### FIELD

This design refers to a new multi-colored crosswalk sign with distinctive 3D vision.

### BACKGROUND

Crosswalk sign is a very important traffic sign to ensure pedestrians to cross the road safely. It leads people in crossing the road and reminds drivers to pay attention to the people crossing the road.

The universal crosswalk sign at present is a white (or yellow) plane rectangle. This kind of crosswalk sign has a defect: many major accidents are caused by the fact that it can only be seen when you are very close since it is easily neglected by drivers as it is plane. As a result, a kind of more bright and distinctive crosswalk sign is needed.

### CONTENT

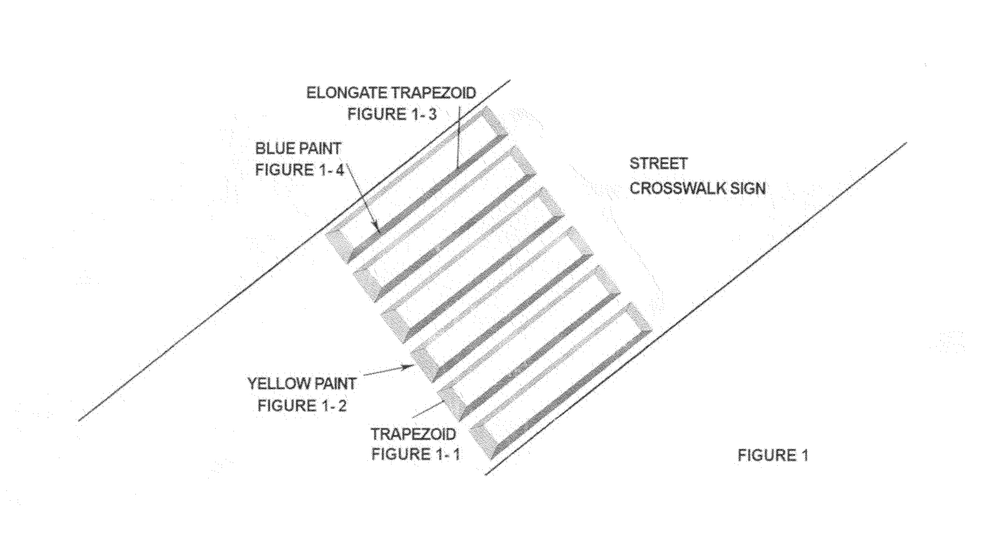

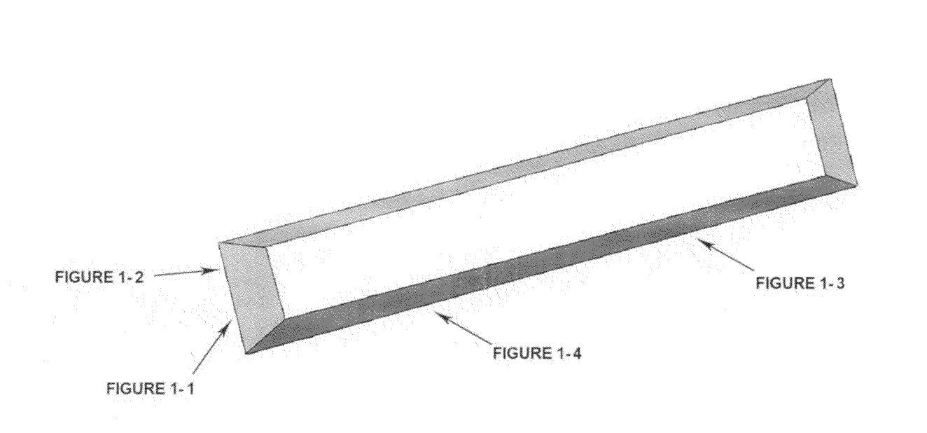

With the aim to overcome the defect of the crosswalk, a new multi-colored crosswalk sign with distinctive 3D vision is designed. (FIG. 1)

The new multi-colored crosswalk sign has the following new designs:

1. Two trapezoids are added to the white rectangle in the crosswalk lane lines (FIG. 1-1), which are painted yellow (FIG. 1-2).

2. The parallel elongate trapezoids on both sides of the white rectangle in the crosswalk lane line (FIG. 1-3) are painted blue or other colors (FIG. 1-4).

3. The trapezoids at both ends of the white rectangle in the crosswalk lane lines and the parallel elongate trapezoids on both sides can also be painted with fluorescer so that the crosswalk lane lines are more distinctive at night.

Such multi-colored crosswalk sign has a more distinctive 3D vision that pedestrians and drivers can see it far away. The distinctive 3D vision reveals a precise information to the drivers and reduces the drivers' chances of rushing across the crosswalk and thus reduces the accidents.

1. A new multi-colored crosswalk sign is characterized by distinctive 3D vision.

2. As stated in claim 1, it is a new multi-colored crosswalk sign, the crosswalk lane lines of which are still designed as white rectangle.

3. As stated in claim 1, it is a new multi-colored crosswalk sign, with trapezoids added at both ends of the white rectangle.

4. As stated in claim 1, it is a new multi-colored crosswalk sign as the trapezoids part at both ends of the white rectangle are painted yellow.

5. As stated in claim 1, it is a new multi-colored crosswalk sign as the parallel elongate trapezoids are designed on both sides of the white rectangles.

6. As stated in claim 1, it is a new multi-colored crosswalk sign as the parallel elongate trapezoids on both sides of the white rectangle are painted blue.

7. As stated in claim 1, it is a new multi-colored crosswalk sign as the parallel elongate trapezoids on both sides of the white rectangle can be also painted with other colors.

8. As stated in claim 1, it is a new multi-colored crosswalk sign as the trapezoids at both ends of the white rectangle in the crosswalk lane lines and the parallel elongate trapezoids on both sides can be also painted with fluorescer.
